(19) United States
(12) Patent Application Publication
(10) Pub. No.: US 2008/0186598 A1
(43) Pub. Date: Aug. 7, 2008

(54) IMAGING LENS REEL-OUT EQUIPMENT

(75) Inventor: Masaki Tsuchiya, Tokyo (JP)

Correspondence Address: DARBY & DARBY P.C., P.O. BOX 770, Church Street Station, New York, NY, 10008-0770, US

(73) Assignee: SMK CORPORATION, Tokyo (JP)

(21) Appl. No.: 11/863,864

(22) Filed: Sep. 28, 2007

(30) Foreign Application Priority Data
Feb. 5, 2007 (JP) 2007-025528

(51) Int. Cl. G02B 7/04

(52) U.S. Cl. 359/823

(57) ABSTRACT

An imaging lens extending apparatus includes a circuit substrate mounting an imaging sensor device; a tubular guide part; a tubular rotary body that includes a switching lever; a macro core; an imaging lens group fit to the macro core; a wave washer; and a cover which is affixed to the circuit substrate. The tubular rotary body is rotatably fit to the tubular guide part. An annular groove of the macro core slidably fits with a tip part of the tubular guide part. Inclined cam surfaces are provided to an upper surface of the tubular rotary body, having heights that gradually changes along the circumferential direction. Rotational stop projections on the outer circumference of the macro core slidably fit within corner brackets of the pedestal. Rotation of the switching lever causes axial movement of the imaging lens group without rotating the imaging lens group.

### CROSS-REFERENCE TO RELATED APPLICATION

The present application claims priority under 35 U.S.C. § 119 to Japanese Patent Application No. 2007-025528, filed Feb. 5, 2007, and which is hereby incorporated herein by reference in its entirety.

### FIELD OF THE INVENTION

The present invention relates to an imaging lens extending apparatus that moves an imaging lens group in a direction that is perpendicular to the imaging plane of an imaging device, and more particularly, relates to an imaging lens extending apparatus that comprises a switching mechanism that switches the imaging lens between a normal imaging mode and a macro imaging mode.

### BACKGROUND OF THE INVENTION

Conventional imaging lens extending apparatuses of the type disclosed by Japanese Patent No. 3,813,167, which is incorporated herein by reference in its entirety, have a structure wherein an imaging lens group is integrated with the switching lever side, and when the switching lever, which is used to switch the imaging lens between a normal imaging mode and a macro imaging mode, is turned, the imaging lens group also turns. In addition, a conventional imaging lens extending apparatus of the type disclosed by Japanese Patent No. 3,813,167 has a structure wherein a seal material is disposed at a portion on the outer side (in the radial direction) of the location where the rotating portion of the system slides with respect to the fixed portion of the system.

Nevertheless, with a conventional imaging lens extending apparatus of this type, there is a problem in that, when the switching lever is turned, the imaging lens group also turns, and therefore, if there is an axial deviation between the axis of the imaging lens extending apparatus and the optical axis of the imaging lens group, then the rotation of the imaging lens group will change the orientation of the optical axis of the imaging lens group, which makes it impossible to obtain a proper image. In addition, with a conventional imaging lens extending apparatus of this type, there is a problem in that abrasion powder that is generated at the sliding location between the fixed system portion and the rotary system portion migrates to the imaging lens group side and contaminates the lens.

### SUMMARY OF THE INVENTION

It is an object of the present invention to provide an imaging lens extending apparatus wherein the orientation of the optical axis of an imaging lens group does not change when a switching lever rotates.

It is another object of the present invention to provide an imaging lens extending apparatus that can prevent the migration of abrasion powder generated at the sliding location between the fixed system portion and the rotary system portion to the imaging lens group side.

To solve the problems of the conventional art as discussed above and to achieve the desired object, the present invention according to a first aspect of the invention is an imaging lens extending apparatus that comprises, in an overlaid configuration: a circuit substrate, whereon an imaging sensor device is mounted that is centered on a central vertical axis; a pedestal, which has a window that surrounds the axis and that corresponds to the imaging sensor device, that is fixed to the circuit substrate; a tubular rotary body, which is annularly formed with a switching lever that is concentric with the axis, that is disposed above the pedestal; a macro core, wherein a female thread is provided to its inner circumferential surface; a lens holder that has a built-in imaging lens group and that has a male thread at its outer circumference that screws into the female thread; an urging means; and a cover, which has an opening at its center; wherein: the cover is fastened and fixed to the pedestal; a tubular guide part is protrusively provided on the pedestal so that it is coaxial with the axis; the tubular rotary body is rotatably fit to the outer circumference of the tubular guide part; and the lens holder, which includes the imaging lens group, moves in the axial directions attendant with the rotation of the tubular rotary body around the axis; wherein an annular groove, wherein a tip part of the tubular guide part fits, is provided to a lower surface of the macro core; the annular groove of the macro core slidably fits with the tip part of the tubular guide part; a plurality of inclined cam surfaces is provided to the upper surface of the tubular rotary body, and the height of each inclined cam surface in the axial directions gradually changes along the circumferential direction; projections, each of which contacts a corresponding inclined cam surface, are provided to the lower surface of the macro core; and by the rotation of the plurality of inclined cam surfaces attendant with the rotation of the tubular rotary body around the axis, each projection changes its position of contact with the corresponding inclined cam surface, and the macro core, which comprises the lens holder, moves in the axial directions.

The present invention of a second aspect of the invention is an imaging lens extending apparatus according to the first aspect of the invention, wherein the tip part of the tubular guide part is fit to the annular groove of the macro core via a seal ring; and an annular seal part is formed on the inner side of the tubular rotary body in the radial direction.

With an imaging lens extending apparatus according to the present invention, an annular groove, wherein a tip part of the tubular guide part fits, is provided to a lower surface of the macro core and the annular groove of the macro core slidably fits with the tip part of the tubular guide part, and therefore it is possible to move the macro core in the axial directions with the tubular guide part serving as a guide. In addition, a plurality of inclined cam surfaces is provided to the upper surface of the tubular rotary body, and the height of each inclined cam surface in the axial directions gradually changes along the circumferential direction; projections, each of which contacts a corresponding inclined cam surface, are provided to the lower surface of the macro core; and, by the rotation of the plurality of inclined cam surfaces attendant with the rotation of the tubular rotary body around the axis, each projection changes its position of contact with the corresponding inclined cam surface, and the macro core, which comprises the lens holder, can move in the axial directions. Consequently, according to the present invention, the imaging lens group can move in the directions of the axis without rotating when the switching lever rotates, and consequently has an advantage in that the orientation of the optical axis of the imaging lens group does not change.

In addition, because the tip part of the tubular guide part is fit to the annular groove of the macro core via the seal ring, and because the seal part is formed on the inner side of the tubular rotary body in the radial direction, the seal part is present on the inner side of the sliding locations in the radial direction between the inclined cam surfaces and the projections that contact such, which makes it possible to prevent the migration of the abrasion powder generated at these sliding locations to the imaging lens group side.

### BRIEF DESCRIPTION OF THE DRAWINGS

The invention will become more readily apparent from the Detailed Description of the Invention, which proceeds with reference to the drawings, in which:

FIG. 1 is an exploded oblique view of one embodiment of an imaging lens extending apparatus according to the present invention.

FIG. 2 is an oblique view of the imaging lens extending apparatus of FIG. 1.

FIG. 3 is a longitudinal cross sectional view of the imaging lens extending apparatus of FIG. 1.

In the figures, elements that are repeatedly illustrated are consistently identified by a single reference numeral.

### DETAILED DESCRIPTION OF THE INVENTION

The following table provides a key to the reference numerals and elements depicted in the drawings:
1 Imaging sensor device
2 Axis
3 Circuit substrate
4 Infrared filter
5 Window
6 Pedestal
7 Switching lever
8 Tubular rotary body
9 Seal ring
10 Female thread
11 Macro core
12 Imaging lens group
13 Male thread
14 Lens holder
15 Wave washer
16 Opening
17 Cover
18 Wirebonding interconnection
19 Corner bracket
19a Recessed part
20 Hook projection
21 Tubular guide part
22 Inclined cam surface
23 Annular groove
24 Projection
25 Seal part
26 Rotational stop projection
27 Recessed part
28 Hook loop

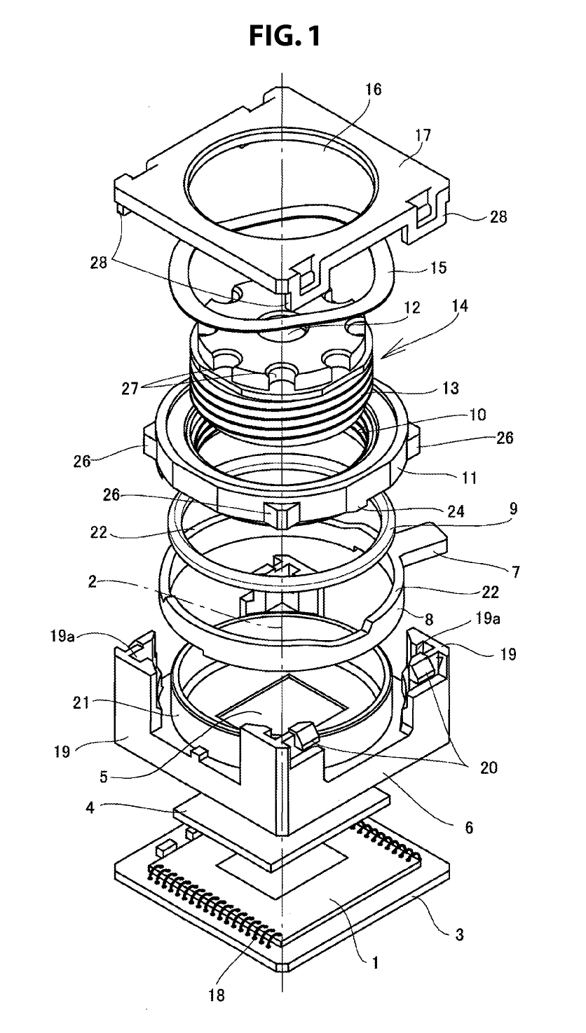

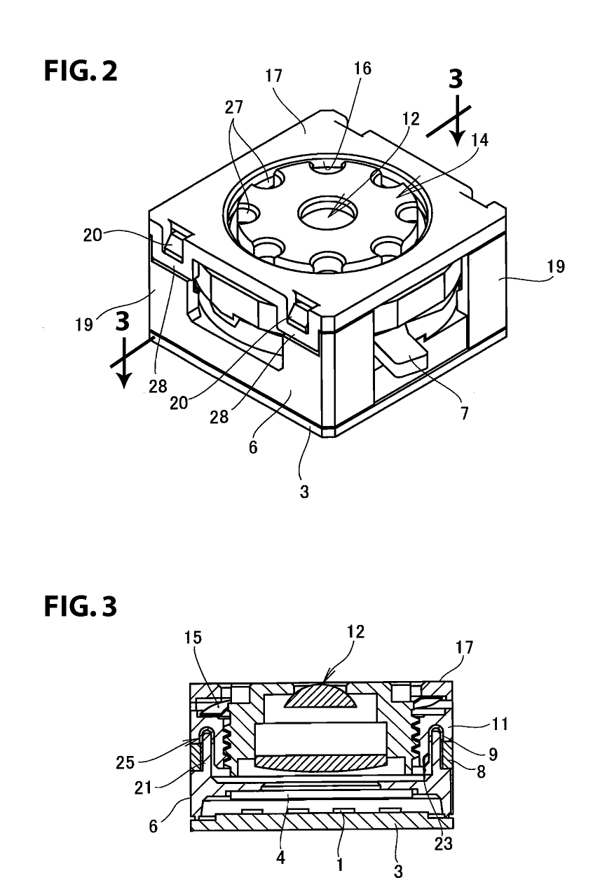

The following explains in detail a preferred embodiment of an imaging lens extending apparatus according to the present invention, referencing an embodiment shown in FIGS. 1-3. Here, FIG. 1 is an exploded oblique view of the imaging lens extending apparatus of the present embodiment, FIG. 2 is an oblique view of the imaging lens extending apparatus of the present embodiment in its assembled state, and FIG. 3 is a longitudinal cross sectional view of the imaging lens extending apparatus of the present embodiment.

As shown in FIG. 1, the imaging lens extending apparatus of the present embodiment comprises, in an overlaid configuration: a circuit substrate 3, whereon an imaging sensor device 1 is mounted that is centered on a central vertical axis 2; an infrared filter 4; a pedestal 6 which has a window 5 that surrounds the axis 2 and that corresponds to the imaging sensor device 1 that is fixed to the circuit substrate 3; a tubular rotary body 8 which is annularly formed with a switching lever 7 that is concentric with the axis 2 that is disposed above the pedestal 6; a seal ring 9; a macro core 11 having a female thread 10 that is provided to its inner circumferential surface; a lens holder 14 that has a built-in imaging lens group 12 and that has a male thread 13 at its outer circumference that screws into the female thread 10; an annular wave washer 15 which serves as an urging means; and a cover 17 which has an opening 16 at its center.

The circuit substrate 3, for example, is formed as a quadrilateral upon which the quadrilateral imaging sensor device 1 is mounted, centered on the vertical axis 2 at the center of the circuit substrate 3, and then connected to the circuit substrate 3 by a wire bonding interconnection 18 or other suitable bonding technique. The infrared filter 4 is overlaid on the imaging sensor device 1. The quadrilateral pedestal 6, which has the window 5 that surrounds the axis 2, is mounted on the circuit substrate 3. The pedestal 6 may be fixed to the circuit substrate 3 for example by an adhesive. A corner bracket 19 is protrusively provided to each of the four corners of an upper surface of the pedestal 6. A hook projection 20 is protrusively provided to an outer surface of each of the corner brackets 19 on the side that correspond to one of two opposing sides of the quadrilateral pedestal 6. An annular tubular guide part 21 is protrusively provided to the upper surface of the pedestal 6 such that it is coaxial with the axis 2.

The annular tubular rotary body 8, which includes the switching lever 7, is rotatably fit to the outer circumference of the tubular guide part 21. Inclined cam surfaces 22 are provided, for example, successively at 120° intervals to the upper surface of the tubular rotary body 8, and the height of each cam surface 22 in the axis 2 direction gradually changes along the circumferential direction of the cam surface 22. As illustrated for example in FIG. 1, the height of each of the inclined cam surfaces 22 has gradually increases in the clockwise direction.

An annular groove 23 is provided on a lower surface of the macro core 11, and which is fit to a tip part of the tubular guide part 21. Projections 24, each of which contacts a corresponding inclined cam surface 22 on the outer side of the annular groove 23 in the radial direction, are provided to the lower surface of the macro core 11. An annular seal part 25, wherein the annular groove 23 of the macro core 11 is fit via the seal ring 9, is formed at the tip part of the tubular guide part 21. The macro core 11 is configured so that the tubular guide part 21, which is fit to the annular groove 23 thereof, functions as a guide and is slidable in the directions of the axis 2. Rotational stop projections 26 are protrusively provided to the outer circumference of the macro core 11, for example, at 90° intervals in its outer circumferential direction. Each of these rotational stop projections 26 fits in an inward facing recessed part 19a of each of the corner brackets 19 in the four corners of the pedestal 6, and serves as a rotary stop of the macro core 11. The male thread 13 of the lens holder 14, wherein the imaging lens group 12 is built in, is screwed into and fixed to the female thread 10 on the inner circumference of the corner brackets 19. A plurality of recessed parts 27 for rotating the lens holder 14 may be provided to an upper surface thereof.

The annular wave washer 15 is overlaid on the upper surface of the macro core 11, and the quadrilateral cover 17, which has an opening 16 at its center, is overlaid on the upper surface of the lens holder 14. Hook loops 28, which correspond to the hook projections 20 of the pedestal 6, are provided to the cover 17 so that they protrude downward. Each of the hook loops 28 is fit, fastened, and fixed to the corresponding hook projection 20 of the pedestal 6 by pressing the cover 17 toward the pedestal 6 side.

With such an imaging lens extending apparatus, the inclined cam surfaces 22 on the tubular rotary body 8 upper surface rotate attendantly with the rotation of the tubular rotary body 8 around the axis 2 due to the rotational operation of the switching lever 7. By the rotation of the inclined cam surfaces 22, each projection 24 of the macro core 11 gradually changes its position of contact with the corresponding inclined cam surface 22, the macro core 11 gradually moves in the directions of the axis 2, and the distance of the lens holder 14, which comprises the imaging lens group 12, to the imaging sensor device 1 changes.

With this structure, the imaging lens group 12 can move in the direction of the axis 2 without rotating when the switching lever 7 rotates, and consequently, has an advantage in that the orientation of the optical axis of the imaging lens group 12 does not change substantially.

In addition, because the tip part of the tubular guide part 21 of the pedestal 6 is fit to the annular groove 23 of the macro core 11 via the seal ring 9, and the seal part 25 is formed on the inner side of the tubular rotary body 8 in the radial direction and is present on the inner side of the sliding locations in the radial direction between the inclined cam surfaces 22 and the projections 24 that contact such, which makes it possible to curtail the migration of the abrasion powder generated at these sliding locations to the imaging lens group 12 side.

It is within the scope of the present invention to include all foreseeable equivalents to the structures described with reference to FIGS. 1-3. For example, although the structure illustrated in FIGS. 1-3 used a wave washer 15 as an urging means for maintaining contact between the inclined cam surfaces 22 and projections 24, but the present invention is not limited to the use of such urging means, but may for example alternatively use a plurality of helical springs that are intermittently disposed between the lens holder 14 and the cover 17 in their circumferential directions around the axis 2 for maintaining contact between the inclined cam surfaces 22 and projections 24.

What is claimed is:

1. An imaging lens extending apparatus comprises, in an overlaid configuration:
a circuit substrate, whereon an imaging sensor device is mounted that is centered on a central vertical axis;
a pedestal, which has a window that surrounds the axis and that corresponds to the imaging sensor device, that is fixed to the circuit substrate;
a tubular rotary body, which is annularly formed with a switching lever that is concentric with the axis, that is disposed above the pedestal;
a macro core, wherein a female thread is provided to its inner circumferential surface;
a lens holder that has a built-in imaging lens group and that has a male thread at its outer circumference that screws into the female thread;
a spring; and
a cover, which has an opening at its center;
wherein:
the cover is fastened and fixed to the pedestal;
an annular tubular guide part is protrusively provided on the pedestal so that it is coaxial with the axis;
the tubular rotary body is rotatably fit to the outer circumference of the tubular guide part; and
the lens holder, which includes the imaging lens group, moves in the axial directions attendant with the rotation of the tubular rotary body around the axis;
wherein
an annular groove, wherein a tip part of the tubular guide part fits, is provided to a lower surface of the macro core;
the annular groove of the macro core slidably fits with the tip part of the tubular guide part;
a plurality of inclined cam surfaces is provided to the upper surface of the tubular rotary body, and the height of each inclined cam surface in the axial directions gradually changes along the circumferential direction;
projections, each of which contacts a corresponding inclined cam surface, are provided to the lower surface of the macro core; and
by the rotation of the plurality of inclined cam surfaces attendantly with the rotation of the tubular rotary body around the axis, each projection changes its position of contact with the corresponding inclined cam surface, and the macro core, which comprises the lens holder, moves in the axial direction.

2. An imaging lens extending apparatus according to claim 1, wherein
the tip part of the tubular guide part is fit to the annular groove of the macro core via a seal ring; and
an annular seal part is formed on the inner side of the tubular rotary body in the radial direction.

3. An imaging lens extending apparatus, comprising:
a pedestal having an annular tubular guide part which is concentric with an axis;
a tubular rotary body that is rotatably fit to the outer circumference of the tubular guide part, the tubular rotary body having a plurality of inclined cam surfaces is provided to an upper surface;
a lens holder having a built-in imaging lens group, the lens holder being affixed to a macro core, the macro core further including a plurality of projections each contacting one of the plurality of inclined cam surfaces;
wherein by the rotation of the plurality of inclined cam surfaces attendantly with the rotation of the tubular rotary body around the axis, each projection changes its position of contact with the corresponding inclined cam surface, causing the macro core and the lens holder to move in the axial direction.

4. An imaging lens extending apparatus according to claim 3, further comprising:
a switching lever that is integrally formed with the tubular rotary body for switching between at least two axial positions of the imaging lens group.

5. An imaging lens extending apparatus according to claim 3, further comprising:
a cover that is affixed to the pedestal; and
a spring that is interposed between the cover and the macro core, and configured to generate a force for urging the plurality of projections to contact the plurality of inclined cam surfaces.

6. An imaging lens extending apparatus according to claim 3, further comprising:
a circuit substrate that is affixed to the pedestal and that mounts an imaging sensor device that is centered on the axis.

7. An imaging lens extending apparatus according to claim 3, further comprising:
an annular groove provided to a lower surface of the macro core,
wherein a tip part of the tubular guide part is fit to the annular groove of the macro core; whereby an annular seal part is formed on an inner side of the tubular rotary body in the radial direction.

8. An imaging lens extending apparatus according to claim 7, wherein the tip part of the tubular guide part is fit to the annular groove of the macro core via a seal ring.

9. An imaging lens extending apparatus according to claim 3, further comprising:
one or more brackets integral with or affixed to the pedestal the brackets being longitudinally directed along a direction that is parallel to the axis; and
one or more rotational stop projections projecting from an outer circumference of the macro core,
wherein the one or more rotational stop projections are each fit to one of the one or more brackets and are slidable in a direction parallel to the axis, whereby the macro core and the lens holder are restrained only to move in the axial direction.
